(19) United States
(12) Patent Application Publication
(10) Pub. No.: US 2005/0108027 A1
(43) Pub. Date: May 19, 2005

(54) Method and apparatus for collecting gambling statistics and for selling speculations via a cryptographically-assisted network

(76) Inventor: Lee Chan Horger, Plymouth, MI (US)

Correspondence Address: Lee Chan Horger, 46965 Burning Tree, Plymouth, MI, 48170, US

(21) Appl. No.: 10/713,702

(22) Filed: Nov. 17, 2003

(51) Int. Cl. G06F 17/60

(52) U.S. Cl. 705/1; 705/10

(57) ABSTRACT

The present invention is a method and apparatus for monitoring gambling statistics and for allowing buyers to purchase information pertaining to a specific bidder's choice. The present invention allows a person to anonymously place a bid about a certain game, without exchanging money to play or for wins or losses. The present invention further allows a person to monitor one's personal gambling statistics, such as wins and losses, and anonymously displays these statistics for others to view. When a person reaches a level of achievement, the present invention tenders an offer of payment in exchange for allowing his/her bidding information, such as choice of winner, number of points, etc., to be sold to others. Potential buyers are given the ability to provide payment to view bidding information. The method and apparatus of the present invention have applications on the Internet as well as conventional communication systems such as voice telephone.

### CROSS-REFFERENCE TO RELATED APPLICATIONS

U.S. Pat. No. 5,794,207

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The method and apparatus of the present invention relate to electronic speculative gambling further involving electronic contract applications using electronic networks.

2. Description of Prior Art

There are numerous methods and locations for individuals to gamble with monetary risks and rewards or for pure speculation. Studies have also been performed to compile statistical data regarding the success of such individuals. However, such studies are usually performed on groups of individuals sharing certain criteria or on the gambling population as a whole, based upon reports submitted by the gambling establishment. Statistical data regarding an individual's success is not typically collected, and therefore only the individual is aware of his/her success.

The use of such statistics could be extremely useful in determining which individuals have a higher rate of past success, with the purpose of being able to place a bid that is the same or similar to those of the successful gamblers. Providing such information for sale could increase buyers' likelihood of winning, increase the of people willing to try a bid, and provide income to the seller.

Moreover, buyers can choose which seller they wish to purchase the information from based upon the seller's success rate. The cost of the sale may vary depending on the statistics in order to provide a higher payment to those individuals most sought after and encourage those individuals to continue providing such information.

The applicant is unaware of the existence of any commercially-viable gambling system which contains the above features and addresses the above-described shortcomings. Therefore, it is one object of the present invention to set forth a system that allows a user to speculate without risk of money, uses said speculations to collect and compile statistics regarding each user's success, and makes the information regarding the speculation available for sale to other users so that they may use the knowledge to place similar bids at “real” gambling locations.

Another object of the present invention is to allow a user to anonymously make as many speculations as desired and to display in an anonymous manner the success of such speculations, as a whole and/or according to game choice or other criteria.

Yet another object of the present invention is to offer terms of payment to selected users in exchange for the privilege of selling said user's speculation information.

It is a further object of the present invention to allow said user to accept said offer, and to collect information necessary to securely transmit payments at pre-ordained periods of time.

It is another object of the present invention to allow other users to select any seller whose statistics and price are desirable with the intent of viewing specific information concerning the seller's current speculation for the game of choice.

It is yet another object of the present invention to securely receive identification of a means of payment for the information desired, with the payment typically being in the form of a credit card account.

A further object of the present invention is to confirm the validity of the account, to determine that sufficient funds are available, and to procure payment.

Yet a further object of the present invention is to display the information purchased only to the buyer.

It is further an object of the invention to hold seller's portion of the payment in escrow until such time that payment should be sent to the seller.

These and other objects of the invention will be apparent to those skilled in the art from the following detailed description of the invention, the accompanying drawings and the appended claims.

### SUMMARY OF THE INVENTION

In a preferred embodiment, the present invention provides a method and apparatus for users to make speculations as to the outcome of a particular game of choice, to compile and display statistical data regarding the success of said speculations and to offer payment to those users who achieve a certain desired level of success. Additionally, users may choose to pay for the information specific to a seller's current speculation and use that information at another location where bids involving transactions of money can be submitted.

In one embodiment of this invention, all communications are conducted using an electronic network and central controller. A user accesses the central controller located at a remote server in order to select a game of choice and to submit an anonymous speculation, much as if a bet were being made. After the outcome of the game of choice is made known to the public, the outcome is entered into the central controller, either by manual data entry or by digital transmission to the central controller from a separate apparatus.

The central controller of this invention will then compile statistical data regarding the accuracy of the user's speculation compared to the outcome of the game of choice and the accuracy of the user's previously submitted speculations. This statistical data is displayed for each user, or a selection of users, for each game of choice with the identity of the user remaining anonymous.

A payment offer (PO) is transmitted along with the terms and conditions from the central controller via the electronic network to any user whose statistics meet or exceeds a desirable level of success with their speculations. The user will then communicate his/her acceptance or rejection of said offer. Users who accept a PO become designated as sellers, and the central controller will denote them on the display of user's statistical data.

Other users (“buyers”, or “potential buyers”) may desire to view the specific information about a particular seller's speculation for a game of choice. For a sports game, this information may include, but is not limited to: which team will win, differences in final scores, and/or if a certain player will score at least so many points. The buyer will select a seller based upon statistical information displayed about the seller and the price of the sale. The central controller will then transmit a purchase agreement to the buyer detailing the type of information being sold, the price, and other terms and conditions of the sale. Buyers may also have the option of purchasing information related to the frequency of a speculation (e.g. team most bid upon, lotto numbers most frequently used, etc.) rather than a specific user's speculation. In this case, payment is typically to the managing company and not to any specific user.

If the buyer still agrees with the sale and wishes to continue, he/she will then be prompted by the central controller to enter payment information, such as a credit card account. The central controller then may ensure that the buyer has sufficient credit available to cover the purchase price specified. The information being purchased will then be made available to the buyer, usually by digital transmission from the central controller via the electronic network.

The central controller also manages transmission of payment to the seller, and this may be only a portion of the sale price, with the remainder of the sale being retained by the company managing the central controller. Payment to the seller may involve the use of an escrow account until a pre-determined amount of time has passed and/or until a certain amount of funds has accumulated in the escrow account.

The central controller may manage the payment system to the buyer and/or from the seller automatically. The payment system may also include a series of checks and balances to ensure accuracy, which may also include review by non-electrical means. Various methods of payment may be utilized, including credit cards, personal or company checks, electronic funds transfer, debit cards, and digital cash.

In yet another embodiment of this invention, the PO may be transmitted to the potential seller via numerous means including a world-wide-web interface, electronic mail, voice mail, facsimile, or postal mail.

Finally, an embodiment of the present invention includes a means of allowing users to post “real” bids rather than just pure speculation as a means of accruing statistical data. In this embodiment, means of payment such as a credit card account and verification of sufficient funds in said account would be necessary to post a speculation. A PO may still be rendered to those users whose statistics meet the desired standards.

What the present invention accomplishes, which no previous system has done before, is to allow users to play a game without risk and see if their speculation would have been successful and to compile the users' statistical data regarding their overall success and/or success for individual games. Additionally, this system of collecting statistics is utilized to determine which patrons are desirable to be offered payment for allowing other users to view their current speculation information, which the other user may use to make “real” bets at legally approved locations.

It is a goal of the present invention to provide a system that meets users' desire to gamble with no risk of losing money and with complete anonymity, of tracking their wins and losses, and of buying the privilege of viewing what the successful gamblers are betting on while keeping the successful gambler's identity unknown to users. The power of a central controller allows this system to operate with minimal or no human interaction necessary to maintain and perpetuate itself.

### BRIEF DESCRIPTION OF THE DRAWINGS

FIG. 1: Apparatus of the invention.

FIG. 2: Apparatus of Central Controller 200.

FIG. 3: Apparatus of User1 Interface.

FIG. 4: Apparatus of User2 Interface.

FIG. 5: Process by which User1 posts a speculation.

FIG. 6: Process by which User1 receives a payment offer.

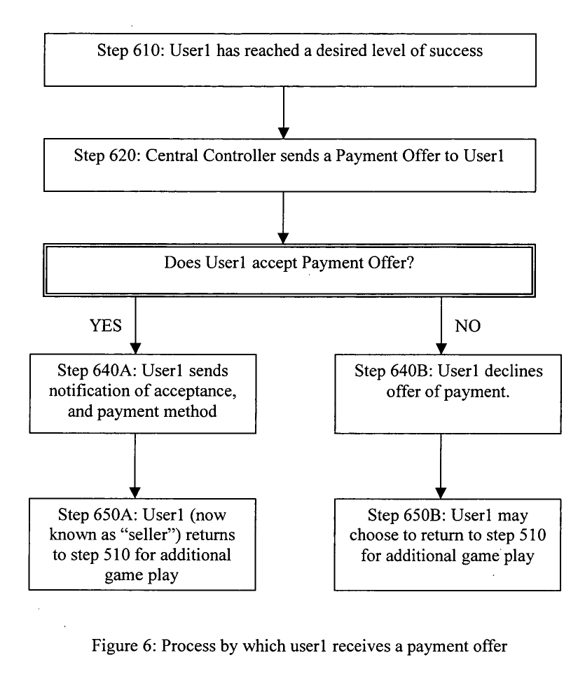

FIG. 7: Process by which User2 purchases speculation details.

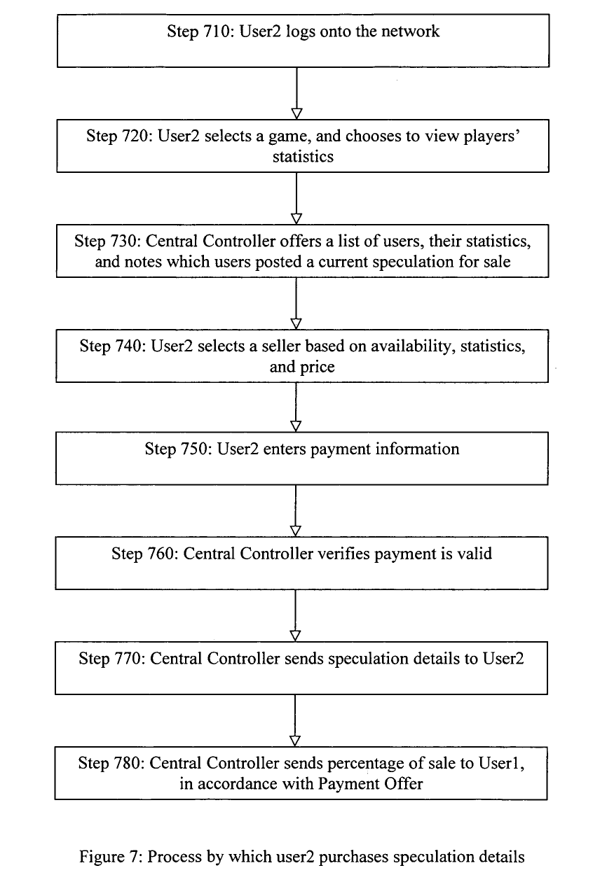

FIG. 8: Process by which payment is made (details of steps 750 through 770).

FIG. 9: Process by which User2 establishes user account.

FIG. 10: Symmetric Key Embodiment.

FIG. 11: Asymmetric Key Embodiment.

FIG. 12: Digital Signatures Embodiment.

FIG. 13: Message Authentication Code Embodiment.

### DETAILED DESCRIPTION OF THE INVENTION

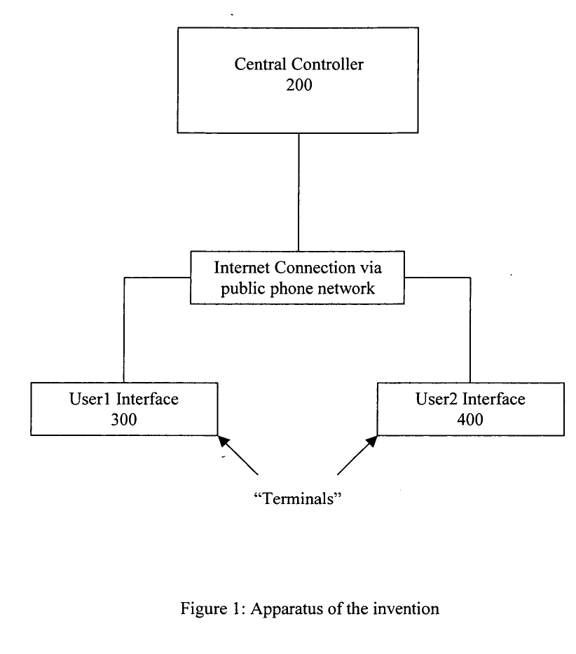

The method an apparatus of the present invention will now be discussed with reference to FIGS. 1, 2, and 3. In a preferred embodiment, the present invention includes central controller 200, user1 interface 300, user2 interface 400, and associated databases. The present invention allows user1 to submit speculations to the central controller, which keeps track of user1's success statistics and may issue a PO. The present invention also allows user2 to see the speculations posted by user1 for a price. Thus, a user may play games with no risk of loss of money or may find out how the more successful players are betting.

System Architecture

The system architecture of a first embodiment of the apparatus and method of the present invention is illustrated with reference to FIGS. 1 through 3. As shown in FIG. 1, the apparatus of the present invention comprises central controller 200, user1 interface 300, and user2 interface 400 (collectively the “terminals”). Each terminal is connected via an Internet connection using a public switched phone network, such as those provided by a local or regional telephone operating company. Connection may also be provided by dedicated data lines, cellular, Personal Communication Systems (“PCS”), microwave, or satellite networks. User1 interface 300 and User2 interface 400 are the input and output gateways for communications with central controller 200.

Using the above components, the present invention provides a method and apparatus for a user to play gambling-type games with out risking loss of money and to find out how the more successful players are betting.

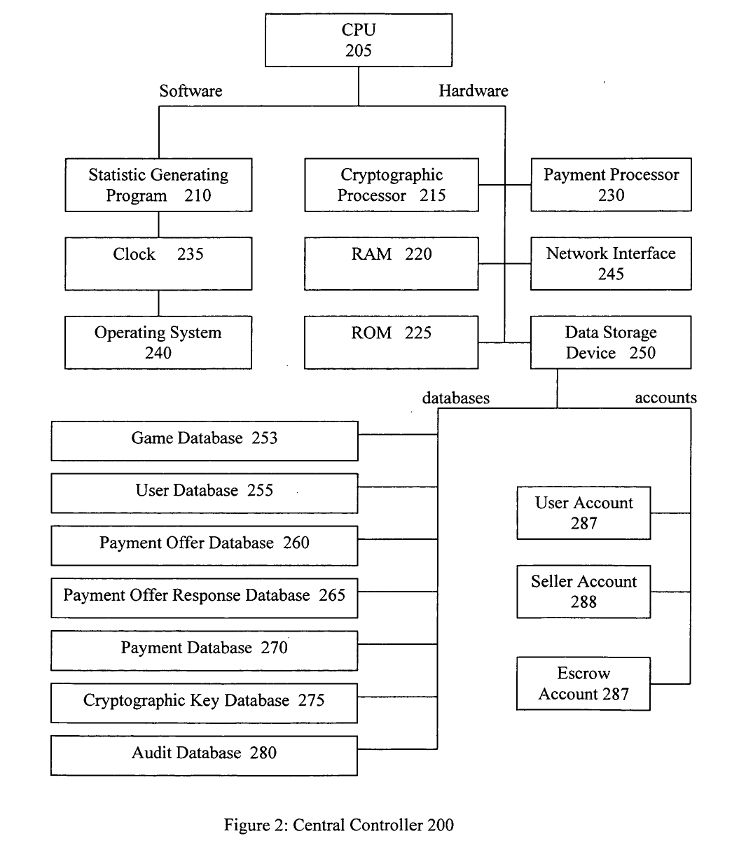

As shown in FIG. 2, central controller 200 includes central processor (CPU) 205, statistic generating program 210, cryptographic processor 215, RAM 220, ROM 225, payment processor 230, clock 235, operating system 240, network interface 245, and data storage device 250.

A conventional personal computer or computer workstation with sufficient memory and processing capability may be used as central controller 200. In one embodiment it operates as a web server, both receiving and transmitting communications to and from users. Central controller 200 must be capable of high volume transaction processing, performing a significant number of mathematical calculations in processing communications and database searches. A microprocessor such as Sun Microsystems' 166 MHz UltraSPARC-1, Motorola's 120 MHz PowerPC 604, Pentium's 100 MHz P54C, or other equivalent processor may be used for CPU 205.

Statistic generating program 210 compiles statistics pertaining to each user's gambling success based on the bids placed and the outcome of the game. Any program capable of such calculations may be used, such as Microsoft's Excel or other comparable program or calculating tool.

A microcontroller may be used for cryptographic processor 215. One such microcontroller utilizes a 16-bit multiply-and-accumulate instruction in the 16 MHz configuration and requires less than one second to perform a 512-bit RSA private key operation. Equivalent processors may also be used. Cryptographic processor 215 supports the authentication of communications from users, as well as allowing for anonymous transactions. Cryptographic processor 215 may also be configured as part of CPU 205. Some commercially available specialized cryptographic processors that would be suitable for use with this present invention include VLSI Technology's 33 MHz 6868, Motorola Inc.'s MC68HC16 or Semaphore Communications' 40 MHz Roadrunner284.

Referring again to FIG. 2, payment processor 230 comprises one or more conventional microprocessors (such as Intel Pentium), supporting the transfer and exchange of payments, charges, or debits, attendant to the method of the apparatus. Payment processor 230 may also be configured as part of CPU 205. Processing of credit card transactions by payment processor 230 may be supported with commercially available software, such as the Secure Webserver manufactured by Open Market, Inc. This server software transmits credit card numbers electronically over the Internet to servers located at the Open Market headquarters where card verification and processing is handled. Their Integrated Commerce Service provides back-office services necessary to run Web-based businesses. Services include on-line account statements, order-taking and credit card payment authorization, credit card settlement, automated sales tax calculations, digital receipt generation, account-based purchase tracking, and payment aggregation for low-priced services.

Data storage device 250 may include hard disk magnetic or optical storage units, as well as CD-ROM drives or flash memory. Data storage device 250 contains databases used in the processing of transactions in the present invention, including game database 253, user database 255, payment offer database 260, payment offer response database 265, payment database 270, cryptographic key database 275, and audit database 280. In a preferred embodiment, database software such as Oracle7, manufactured by Oracle Corporation, is used to create and manage these databases; however, other suitable software may be used. Data storage device 250 also stores information pertaining to user account 287, seller account 288, and escrow account 299.

Game database 253 maintains data on the types of games offered including the dates that actual games occur and the options that pertain to each game-type. After occurrence of the actual game, company will input outcomes into this database to be extracted to and compiled by statistic generating program 210.

User database 255 maintains data on users with fields such as name, address, credit card number, phone number, ID number, social security number, electronic mail address, credit history, public/private key information, etc. This information is obtained when the user first registers with the system. User database 255 also contains records of system usage including current and previous speculations as well as the statistical information 110 extracted from statistic generating program 210.

Payment offer database 260 maintains data pertaining to the level of success desired in order for a PO 120 to be sent to a user, the amount to be charged to users desiring to purchase the information, the amount to be paid to the user whose information is being purchased, and how frequently payment is to be made to said user.

Payment offer response database 265 maintains data on those users who receive a PO 120, the terms and amounts of the offer, whether or not the user accepts the offer (payment offer responses 130), and the preferred method of payment (such as check, electronic funds deposit, payment to a credit card account, or other reasonable means of transferring funds).

Payment database 270 tracks all payments to and from users using fields such as status, date, time, price, last payment sent, and next payment due. This database may also store credit card numbers of users or may instead reference user database 255 and payment offer response database 265 for the appropriate payment information.

Cryptographic key database 275 facilitates cryptographic functions, storing both symmetric and asymmetric keys. These keys are used by cryptographic processor 215 for encrypting and decrypting user information, statistics and bids, PO's 120, payment offer responses 130, and account information.

Audit database 280 stores transactional information relating to PO's 120 and payment offer responses 130, allowing them to be retrieved for later analysis.

User account 287 tracks all information pertaining to the user's account with fields such as user's name, bank and credit account numbers, and debit or credit transactions. This account may be a pointer to account data stored at the user's bank.

Seller account 288 tracks all information pertaining to the seller's account with fields such as seller's name, bank and credit account numbers, and debit or credit transactions, including payment history. User payments for information purchases may also be sent to this account.

Escrow account 289 is an account which temporarily holds user's funds before they are placed in seller account or dispersed to company accounts.

Network interface 245 is the gateway to communicate with users and sellers through respective user1 interface 300 and user2 interface 400. Conventional internal or external modems may serve as network interface 245. Network interface 245 supports modems at a range of baud rates from 1200 upward, but may combine such inputs into a T1 or T3 line if more bandwidth is required. In a preferred embodiment, network interface 245 is connected with the Internet and/or any of the commercial on-line services such as America Online, CompuServe, or Prodigy, allowing users and sellers access from a wide range of on-line connections. Several commercial electronic mail servers include the above functionality. NCD Software manufactures “Post.Office,” a secure server-based electronic mail software package designed to link people and information over enterprise networks and the Internet. The product is platform independent and utilizes open standards based on Internet protocols. Users can exchange messages with enclosures such as files, graphics, video and audio. The system also supports multiple languages. Alternatively, network interface 245 may be configured as a voice mail interface, web site, BBS, or electronic mail address.

While the above embodiment describes a single computer acting as central controller 200, those skilled in the art will realize that the functionality can be distributed over a plurality of computers. In one embodiment, central controller 200 is configured in a distributed architecture, wherein the databases and processors are housed in separate units or locations. Some controllers perform the primary processing functions and contain at a minimum RAM, ROM, and a general processor. Each of these controllers is attached to a WAN hub which serves as the primary communication link with the other controllers and interface devices. The WAN hub may have minimal processing capability itself, serving primarily as a communications router. Those skilled in the art will appreciate that an almost unlimited number of controllers may be supported. This arrangement yields a more dynamic and flexible system, less prone to catastrophic hardware failures affecting the entire system. The trusted server embodiment provides more details of such a distributed environment, describing operations server 160, trusted server 165, and bonding agency 170. The hardware of these servers would be configured similarly to that described for central controller 200.

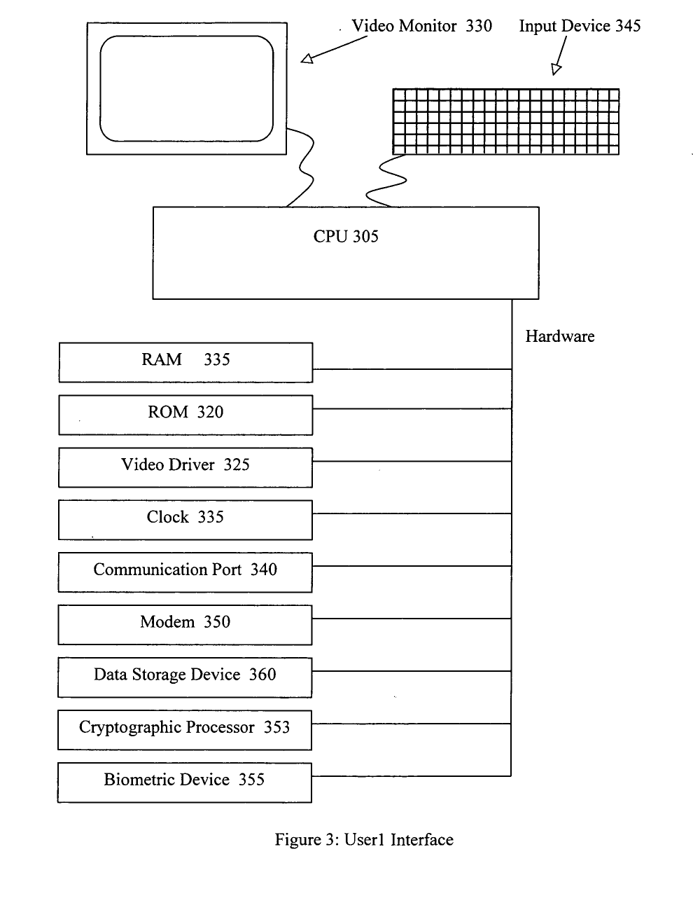

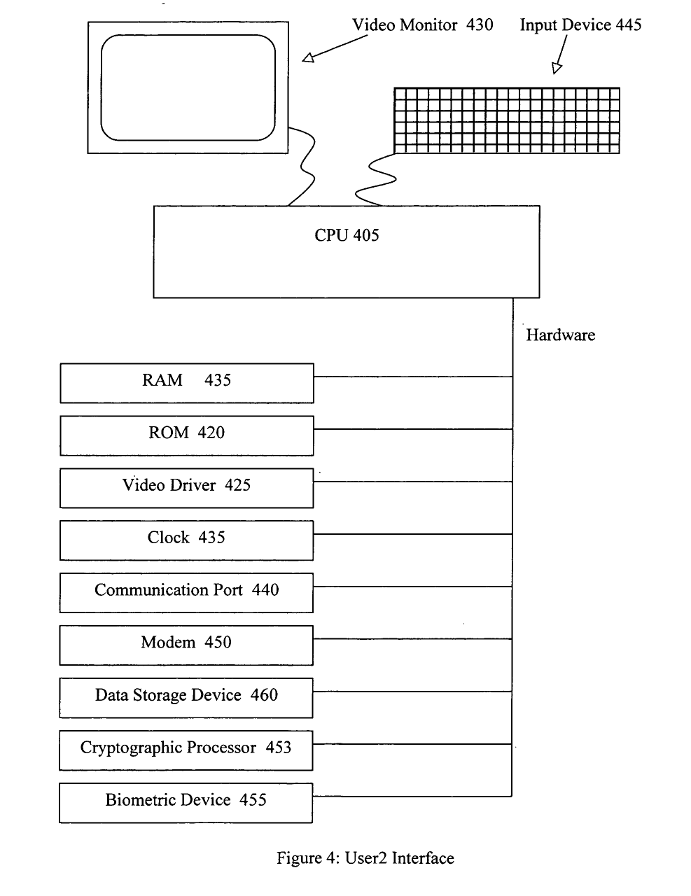

FIGS. 3 and 4 describe user1 interface 300 and user2 interface 400, respectively. In an exemplary embodiment, they are both conventional personal computers having an input device, such as a keyboard, mouse or conventional voice recognition software package; a display device, such as a video monitor; a processing device such as a CPU; and a network interface such as a modem. These devices interface with central controller 200. Alternatively, user1 interface 300 and user2 interface 400 may also be voice mail systems, or other electronic or voice communication systems. As will be described further in the following embodiments, devices such as fax machines or pagers are also suitable interface devices.

Referring now to FIG. 3, there is described user1 interface 300 which includes central processor (CPU) 305, RAM 315, ROM 320, clock 335, video driver 325, video monitor 330, communication port 340, input device 345, modem 350, and data storage device 360. Cryptographic processor 310 and biometric device 355 may be added for stronger authentication as described later. A Pentium microprocessor such as the 100 MHz P54C described above may be used for CPU 305, as could any other suitably comparable microprocessor. Clock 335 is a standard chip-based clock which can serve to timestamp user payment offer response 130 produced with user1 interface 300.

Modem 350 may not require high-speed data transfer if most user payment offer responses 130 are text-based and not too long. If a cryptographic processor is required, the MC68HC16 or other similarly comparable microcontroller described above is used. The structure of biometric device 355 will be described below in conjunction with the cryptographic authentication embodiment.

Data storage device 360 is a conventional magnetic-based hard disk storage unit. Message database 370 may be used for archiving payment offer responses 130 or for storing a cryptographic key as described in a symmetric key embodiment, while audit database 380 may be used for recording payment records and communications with central controller 200.

Referring now to FIG. 4, there is described user2 interface 400 which includes central processor (CPU) 405, RAM 415, ROM 420, clock 435, video driver 425, video monitor 430, cryptographic processor 410, communications port 440, input device 445, modem 450, biometric device 455, and data storage device 460. All of these components may be identical to those described in FIG. 3.

There are many commercial software applications that can enable the communications required by user1 interface 300 or user2 interface 400, the primary function being message creation and transmission. Eudora Pro manufactured by Qualcomm Incorporated, for example, provides editing tools for the creation of messages as well as the communications tools to route the message to the appropriate electronic address. When central controller 200 is configured as a web server, conventional communications software such as the Netscape Navigator web browser from Netscape Corporation may also be used. The user and the seller may use the Netscape Navigator browser to receive PO 120, to transmit payment offer response 130, to view user statistics 110, and/or to make and receive an information purchase 140. No proprietary software is required.

Online Embodiment

In one embodiment of the present invention, communications between users/sellers and the managing company take place via electronic networks, with central controller 200 acting as a web server. The user logs on to central controller 200 via Internet connection, selects a game, submits a speculation 100, and then disconnects from the network. The managing company then inputs the outcome of the game(s) into central controller 200 and users' success statistics are then determined by the statistic generating program 210. Users whose success rate meets or exceeds the desired level (any level can be chosen by the managing company) will be sent a PO 120 for allowing other users to view specific information about their future speculations 100. This offer is submitted via electronic mail or redirection to a payment offer website upon logging on to central controller 200. Users may optionally choose to pay to view a posted speculation 100 by selecting a user/seller appropriate to the game of choice and entering payment information. Central controller would ensure that the buyer has sufficient credit available to meet the price and then information about the user/seller's speculation 100 would be transmitted via the network for display on user's interface via electronic mail or the buyer would be directed to a webpage displaying the purchased information. Payment to the user/seller would be sent periodically in accordance with the terms of PO 120. Periodic maintenance is also performed by central controller 200 to ensure that users/sellers who are indicated as being available for selection by buyers have a current speculation 100 posted and that users whose statistics meet or exceed the desired level have been sent a PO 120.

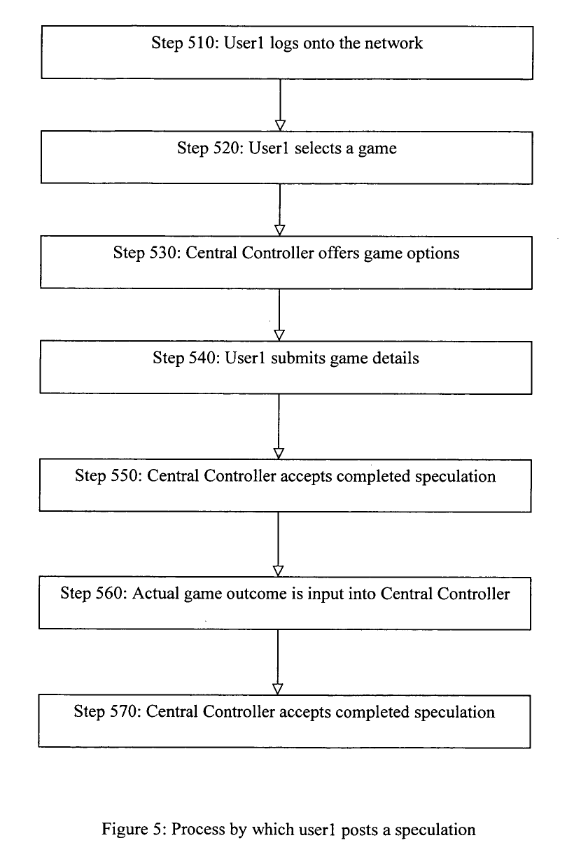

With reference to FIG. 5, there is described the process by which the user posts a speculation 100 to the central processor. After user logs onto the network, he/she selects a game, which may be a sport, casino, and/or lottery-style game. If the user selects one of the sports, additional options are offered, such as choice of winning team for a particular game, difference in points between teams for a specific game, and other variations and options that are typically offered to sports gamblers. Similarly, if the user selects a casino or lottery-style game, he/she may choose from the same kinds of options offered in the actual games. In any of the games, a theoretical monetary amount may also be associated with speculation 100 for purposes of tracking the amounts “won” or “lost” by a player.

Instead of a world web-based interface, users may also transmit speculations 100 via electronic mail, voice mail, facsimile, or postal mail transmissions. With voice mail, the user calls central controller 200 and leaves game details in audio form. These speculations 100 may be transcribed into digital text at central controller 200, or made available to users purchasing the information in the same audio format. In a postal mail embodiment, central controller acts more like a router, directing speculations 100 to the buyers purchasing the information, creating multiple copies of speculation 100 if necessary. Central controller 200 supports a plurality of transmission methods, allowing for a wide variety of formats of speculations 100. Some formats may be changed, however, before further processing by central controller 200. Speculations 100 transmitted by mail in paper form, for example, may be scanned-in and digitized, using optical character recognition software to create digital text. These embodiments are more fully described in the off-line embodiment described later.

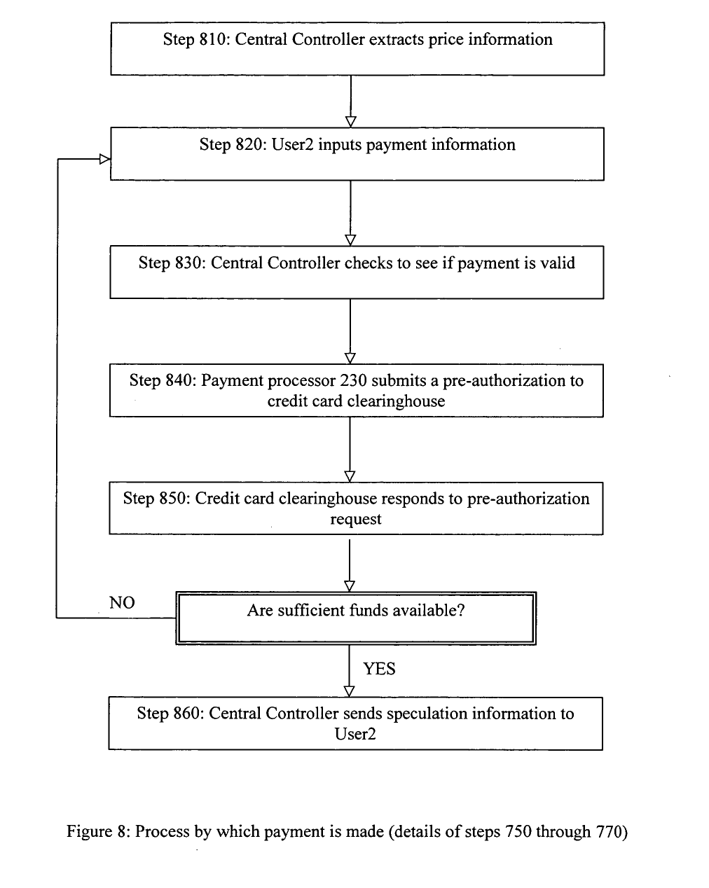

Referring now to FIG. 8, user has selected a game choice, including any options, and users/sellers with a current speculation 100 posted for the game of choice are indicated in the listing of users and their statistics. User may now select from this listing a seller whose speculation he/she desires to view. At step 810, central controller 200 extracts price information from payment database 270. At step 820, user inputs payment information to central controller 200, which checks, at step 830, to see if sufficient credit is available to cover the price of the sale. Payment processor 230 submits a pre-authorization of the price of the sale to the credit card clearinghouse at step 840. This serves to “lock up” a portion of the available credit on the buyer's credit card, preventing him from using up this credit while the transaction is in progress. At step 850, the credit card clearinghouse responds to pre-authorization, indicating whether sufficient credit is available. If sufficient funds are not available to cover the cost of the sale, another credit card is requested from user at step 820. Once an additional credit card has been transmitted, central controller 200 then resubmits the pre-authorization at step 840. This can be repeated until a valid credit card account is submitted with an appropriate amount of credit available.

Once payment has been secured, speculation information is made available to the buyer. In a world web-based embodiment, buyer may be redirected to a secure web-page displaying the information. The central controller may optionally send speculation information via electronic mail, voice mail, facsimile, or postal mail transmissions.

Finally, the seller account 288 is credited with the pre-approved portion of the sale. At appointed times, all funds held in this account is sent to the seller. This can be in the form of a check, money order, electronic transfer, reverse-charge to a credit card account, direct deposit, or other acceptable means of transferring money.

Payment Preferences

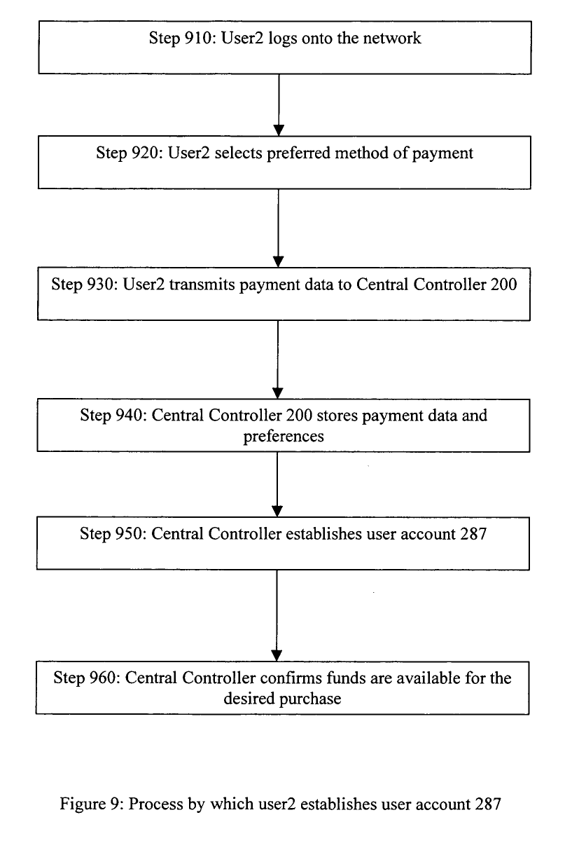

FIG. 9 illustrates a protocol in which central controller 200 establishes user account 297. At step 900, the buyer selects his preferred method of payment. Preferred methods might include credit cards, personal checks, electronic funds transfer, digital money, etc. At step 910, the buyer transmits payment data corresponding to his preferred method of payment to central controller 200. Such payment data might include credit card number or bank account number. These payment methods are meant to be merely illustrative, however, as there are many equivalent payment methods commonly known in the art which may also be used. If the buyer wants to pay by credit card, for example, payment data would include his credit card account number, expiration date, name of issuing institution, and credit limit. For electronic funds transfer, payment data includes the name of the buyer's bank and his account number. At step 920, central controller 200 stores payment data and payment preferences in payment database 270.

At step 930, central controller 200 establishes user account 287 which either stores money transferred by the buyer or serves as a pointer to an account of the buyer outside the system. For buyers using credit cards, for example, user account 287 contains the credit card number, expiration date, and name of issuing institution. Buyers could also transfer money to central controller 200 to be stored in user account 287, which would operate like a conventional checking account. Central controller 200 would send a check to the escrow account 289 and/or to the seller written on user account 287. Alternatively, central controller 200 could electronically move the funds directly from user account 287 to escrow account 289 and/or seller account 288. At step 940, central controller 200 contacts the bank or card issuer to confirm that funds are available. A buyer is thus unable to use a credit card with no credit available to establish user account 287.

The above protocols may be similarly applied to sellers, allowing for the creation of seller account 288. The primary difference being that seller account 288 is primarily used for deposits. Verification of funds available is therefore not as important for sellers.

Although the on-line embodiment describes a protocol in which central controller 200 processes credit card information, there are of course many payment protocols under which payment may be transferred from buyer to company and seller. In one embodiment, central controller 200 looks up the credit card number of the buyer in payment database 270. This credit card number is transmitted to payment processor 230. Payment processor 230 contacts the credit card clearinghouse to get an authorization number. The billable amount appears on the credit card statement of the buyer in his monthly statement. The clearinghouse posts this amount to escrow account 289, an appropriate portion of which is transferred to seller account 288 before being transmitted to seller by payment processor 230. Central controller 200 updates payment database 270 to indicate that payment has been made.

Another method of payment involves procedures using digital cash. Central controller 200 looks up the buyer's electronic delivery address in payment database 270. This address is transmitted to payment processor 230, with the digital cash being downloaded from the buyer. Central controller 200 updates payment database 270 to indicate that payment has been made. This address might be an electronic mail address if the digital cash is to be transferred by electronic mail, or it could by an Internet Protocol address capable of accepting an on-line transfer of digital cash. This electronic delivery address is sent to payment processor 230. The digital cash is downloaded to escrow account 289 and a portion redistributed to seller account 288. Central controller then updates payment database 270 to indicate that payment has been made.

The practice of using digital cash protocols to effect payment is well known in the art and need not be described here in detail. For reference, one of ordinary skill in the art may refer to Daniel C. Lynch and Leslie Lundquist, Digital Money, John Wiley & Sons, 1996; or Seth Godin, Presenting Digital Cash, Sams Net Publishing, 1995.

Off-Line Embodiment

In one embodiment of the present invention, users communicate in an off-line manner with central controller 200. Rather than sending electronic mail or using web-based servers, users use a telephone, fax machine, postal mail, or other off-line communication tool.

A user may use a telephone, for instance, to submit a speculation 100. The user calls central controller 200 and is connected with an agent. The user selects a game choice such as a sport, a lottery-style game, or a casino-style game. The user then provides the terms of the speculation such as teams, points, numbers (as in a lottery-game, roulette game, or other similar game), or cards (as in some casino games). Other terms may include the date of the game (for sports or lottery) and/or monetary amounts of the “bid,” etc. The user also provides his user ID, password, or private key so that central controller can authenticate his identity and for statistic generation. The agent puts this data into digital form by typing it into a terminal. Speculation 100 is then transmitted to central controller 200 where it is made available to potential buyers as described in the on-line embodiment.

In an alternative embodiment, the buyer calls central controller 200 and is connected with a conventional Interactive Response Unit (IVRU) which allows the user to enter the terms of the speculation without the assistance of a live agent. The user initially selects from a menu of subjects using the touch-tone keys of his phone, and then the call is either directed to a live agent specializing in the subject area, or the user is prompted for further terms of speculation 100.

Potential buyers may also use a telephone to browse user statistics and purchase speculation information. The potential buyer calls central controller 200 and selects a game choice. Central controller 200 then reads a list of users with a current speculation available for sale. At any time the potential buyer may press a combination of keys on his telephone to select a user. Buyer then inputs payment information and the payment is verified by payment processor 230. Central controller 200 then converts the text of the speculation into audio form and reads it to the buyer. Potential buyers could also enter parameters before having the list of sellers read to them. For example, the buyer may request for information on users with a success rate of over 80% for more than 15 games played, skipping any seller with a lower rate of success.

Buyers and sellers may also communicate with an agent at central controller through faxes or postal mail. The agent receives the message and proceeds to digitize it and form speculation 100 as described above.

Cryptographic Authentication Embodiment

In the previous embodiments, authentication of users involves checking the attached ID or name and comparing it with those stored in user database 255. Although this procedure works well in a low security environment, it can be significantly improved through the use of cryptographic protocols. These protocols not only enhance the ability to authenticate the sender of a message, but also serve to verify the integrity of the message itself, proving that it has not been altered during transmission. A user could be prevented from playing games under another user's ID and causing a statistic set that reflects the choices made by more than one user. Therefore, potential buyers can be more assured that the success rate is accurate and that the information being purchased was posted by the user with the posted rate of success. Encryption can also prevent eavesdroppers from learning the contents of the message. For example, a user could be prevented from reading any intercepted speculation 100 being sent to or from central controller 200. Such techniques shall be referred to generally as cryptographic assurance methods and will include the use of both symmetric and asymmetric keys as well as digital signatures and hash algorithms.

The practice of using cryptographic protocols to ensure the authenticity of senders as well as the integrity of messages is well known in the art and need not be described here in detail. For reference, one of ordinary skill in the art may refer to Bruce Schneier, Applied Cryptography, Protocols, Algorithms, and Source Code In C (2d Ed, John Wiley & Sons, Inc., 1996).

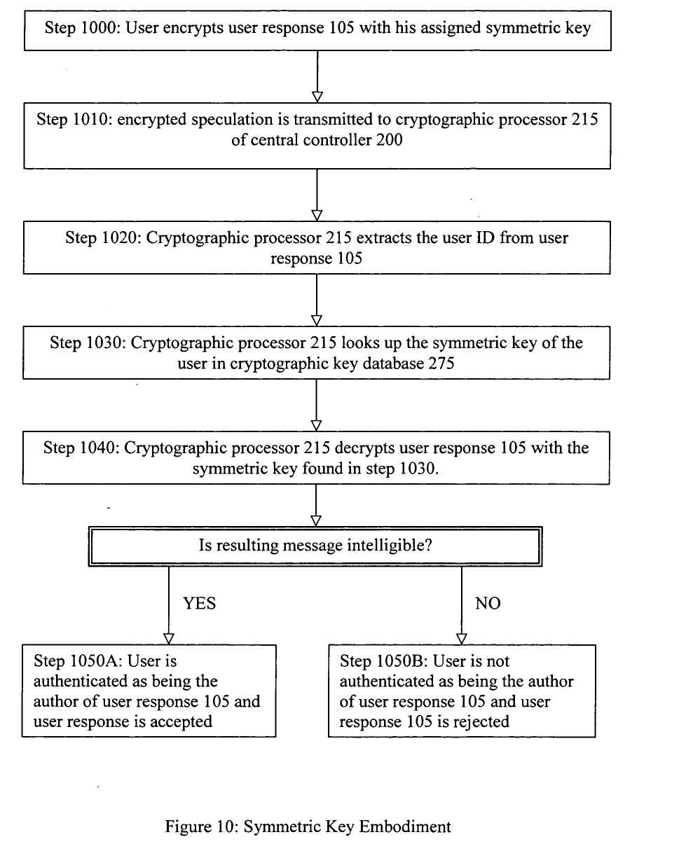

FIG. 10 describes a symmetric key embodiment in which the user and central controller 200 share a key. Thus both encryption and decryption of user response 105 are performed with the same key. This encryption may implemented with an algorithm such as DES (U.S. Government standard, specified in FIPS PUB 46), or with any of several algorithms known in the art such as IDEA, Blorfish, RC4, RC2, SAFER, etc. The user encrypts user response 105 with his assigned symmetric key at step 1000, using cryptographic processor 310/410 of user1 interface 300 or user2 interface 400. The key may be stored in message database 370 or otherwise stored or memorized by the user. The encrypted speculation is then transmitted to cryptographic processor 215 of central controller 200 at step 1010. Cryptographic processor 215 extracts the user ID from user response 105 at step 1020 and looks up the symmetric key of the user in cryptographic key database 275 at step 1030, decrypting user response 105 with this key at step 1040. Cryptographic key database 275 contains algorithms and keys for encrypting, decrypting and/or authenticating messages. At step 1050, if the resulting message is intelligible, then it must have been encrypted by the same key, authenticating that the user must have indeed been the author of user response 105.

This procedure makes it significantly more difficult for an unauthorized user to represent himself as a legitimate user. Without cryptographic procedures, an unauthorized user who obtained a sample user response 105 from a legitimate user would be able to extract the user ID and then attach this ID number to unauthorized user responses 105. When user response 105 has been encrypted with a symmetric key, however, an unauthorized user obtaining a sample user response 105 only discovers the user's ID number, not the symmetric key. Without this key, the unauthorized user cannot create a user response 105 that will not be discovered by central controller 200, since he cannot encrypt his message in the same way that the authorized seller could. The symmetric key protocol also ensures that user response 105 has not been tampered with during transmission, since alteration of the message requires knowledge of the symmetric key. An encrypted user response 105 also provides the user with more anonymity.

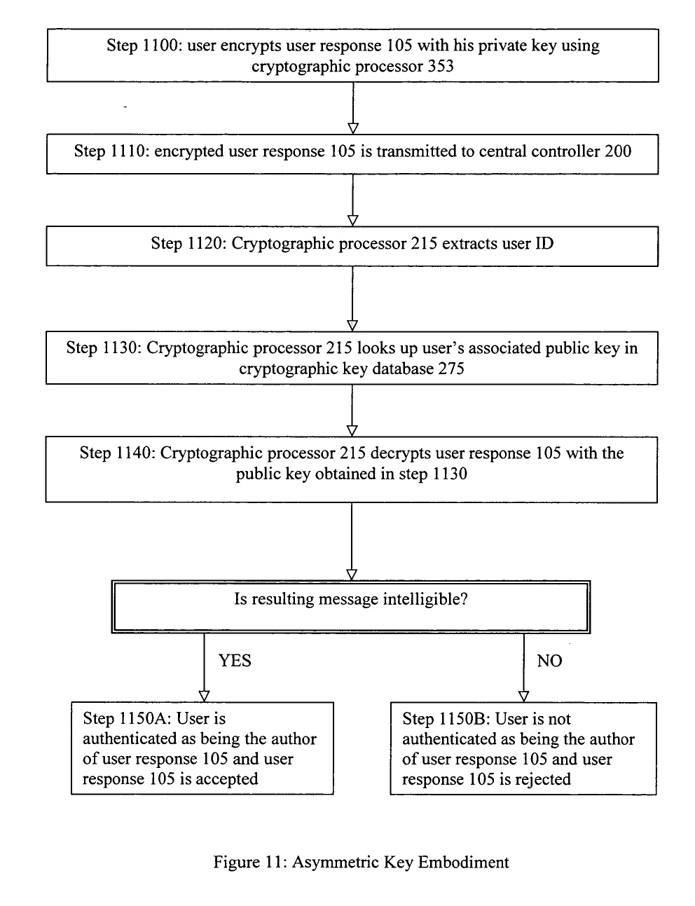

Referring now to FIG. 11, there is shown an asymmetric key protocol in which user response 105 is encrypted with a private key and decrypted with a public key. Two such algorithms for this procedure are RSA and DSA. At step 1100, the user encrypts user response 105 with his private key using cryptographic processor 353, transmitting user response 105 to central controller 200 at step 1110. Cryptographic processor 215 extracts the seller ID at step 1120 and looks up the user's associated public key in cryptographic key database 275 at step 1130, decrypting user response 105 with this public key at step 1140. As before, if user response 105 is intelligible then central controller 200 has authenticated the user at step 1150. Again, unauthorized users obtaining user response 105 before it was received by central controller 200 are not able to undetectably alter it since they do not know the private key of the user. Message secrecy is obtained if the user encrypts user response 105 with his public key, requiring the attacker to know the user's private key to view user response 105.

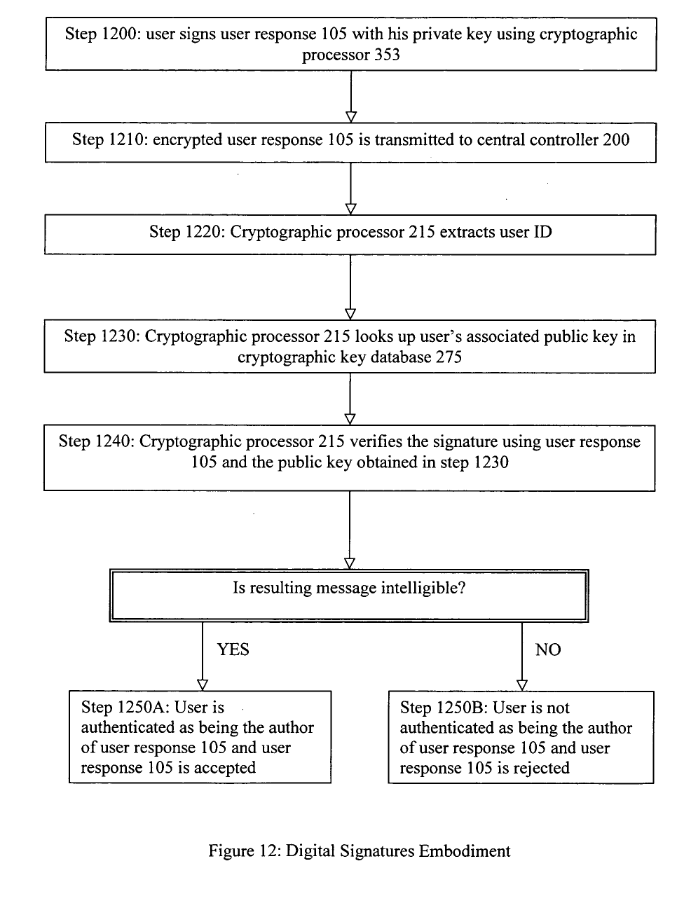

FIG. 12 shows a cryptographic technique using digital signatures to provide authentication and message integrity. One such algorithm is DSA (Digital Signature Algorithm), the U.S. Government standard specified in FIPS PUB 186. As in the symmetric protocol described above, each user has an associated public and private key. The user signs user response 105 with his private key at step 1200 with cryptographic processor 353 and transmits it to central controller 200 at step 1210. Central controller cryptographic processor 215 extracts the user ID at step 1220 and looks up the user's public key at step 1230, verifying the signature using user response 105 and the public key of the user at step 1240. If user response 105 is intelligible, then central controller 200 accepts user response 105 as authentic at step 1250.

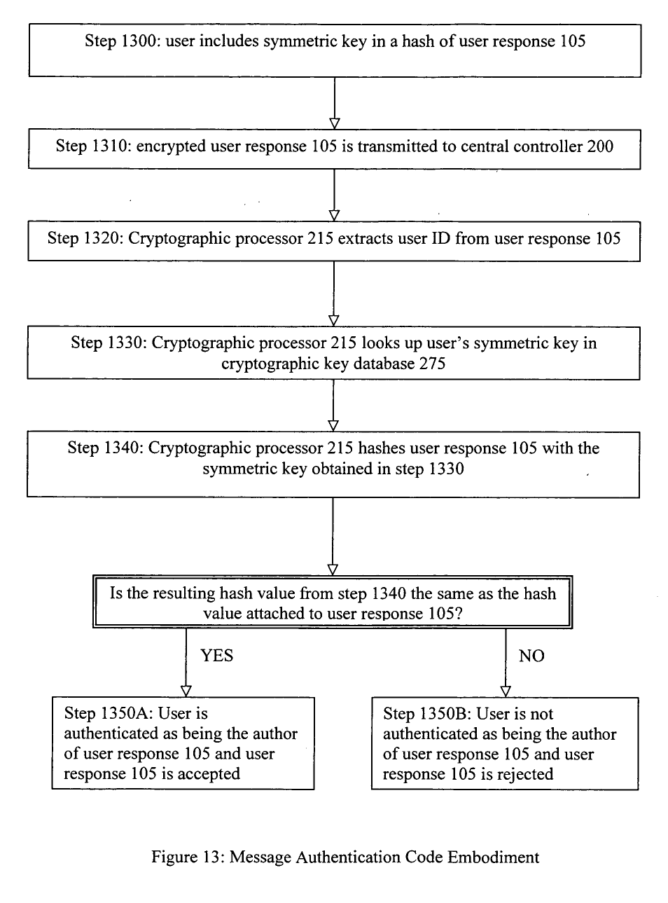

Referring now to FIG. 13, there is described a cryptographic technique using message authentication codes for verifying the authenticity and integrity of user response 105. In the hash protocol of the present invention, the use and central controller 200 share a symmetric key, which the user includes in a hash of user response 105 at step 1300. In the hash protocol, a one-way function is applied to the digital representation of user response 105, generating a code that acts much like the fingerprint of user response 105. Any of the MAC algorithms, such as RIPE-MAC, IBC-Hash, CBC-MAC, and the like may be applied in this application. After transmitting user response 105 to central controller 200 at step 1310, cryptographic processor 215 extracts user ID from user response 105 at step 1320. Then cryptographic processor 215 looks up the user's symmetric key at step 1330 and hashes user response 105 with this symmetric key at step 1340, comparing the resulting hash value with the hash value attached to user response 105. If the values match at step 1350, the integrity of user response 105 is verified along with the authenticity of the user.

Although cryptographic techniques can provide greater confidence in the authenticity of user response 105, they are useless if the user's cryptographic keys are compromised. An attacker obtaining the symmetric key of another user is indistinguishable from that user in the eyes of central controller 200. There is no way to know whether the user was the true author of user response 105, or an attacker with the right cryptographic keys. One way to solve this problem (known as undetected substitution) is to use biometric devices such as a fingerprint reader, voice recognition system, retinal scanner and the like. These devices incorporate a physical attribute of the user into user response 105, which is then compared with the value stored in user database 255 at central controller 200. In the present invention, such devices attach to user1 interface 300 or user2 interface 400.

Fingerprint verification, for example, may be executed before the creation of user response 105, during the generation of user response 105 in response to prompts from central controller 200, at some predetermined or random times, or continuously by incorporating the scanning lens into user1 interface 300 and user2 interface 400 such that the user is required to maintain his finger on the scanning lens at all times for continuous verification while user response 105 is generated.

An example of such an identification device is the FC100 FINGERPRINT VERIFIER available from Startek, a Taiwanese company. The FC100 is readily adaptable to any PC via an interface card. The fingerprint verifier utilizes an optical scanning lens. The user places his finger on the lens, and the resulting image is scanned, digitized, and the data compressed and stored in memory. Typically, a 256 byte file is all that is required. Each live-scan fingerprint is compared against the previously enrolled/stored template, stored in data storage device 360. If the prints do not match, the cryptographic algorithms executed by cryptographic processor 310 may prevent the user from generating a user response 105.

In a voice verification embodiment, the user's voice is used to verify his identity. This embodiment has the advantage of not requiring the use of any specialized hardware since it can be implemented over a standard phone connection. The user's identity is verified at central controller 200. The process of obtaining a voice-print and subsequently using it to verify a person's identity is well-known in the art, and therefore need not be described in detail herein. One of ordinary skill in the art may refer to SpeakEZ, Inc. for voice identification/verification technology. Conventional speaker identification software samples the user's voice. This sample is stored at central controller 200 in user database 255. Each time the user wants to transmit user response 105 to central controller 200, he is required to call central controller 200 and speak into the phone at the prompt for a voice sample. If this sample matches that stored in user database 255, the user is provided a password which is incorporated into the digital signature appended to user response 105. Any user response received without an appropriate voice match password is not accepted. The voice-print may also be stored in a database within data storage device 360/460 of user1 interface 300 and user2 interface 400, to verify the user's identity locally prior to allowing user response 105 to be created.

Although the above cryptographic and biometric protocols describe the authentication and validation of user response 105, they may be equally applied to the authentication and validation of speculation 100, PO 120, payment offer response 130, or any other message or communication between users and central controller 200.

Anonymous Transactions Embodiment

As mentioned previously, the present invention provides for the anonymity of the users. Such anonymity is accomplished by eliminating all references to the names of the individuals for all transactions. A user, for example, would include his ID in speculation 100 rather than his name, preventing other users browsing through game listings from discovering the user's identity. This is desirable if the user did not want others to know that he speculates/gambles/places bids. Although using ID numbers can provide anonymity for users, there are a number of potential weaknesses. First, if the database of ID numbers, stored in user database 255, and its users is compromised, anonymity is destroyed since the message coder can be looked up in user database 255. To prevent this, the ID numbers are encrypted with the public key of central controller 200, so that even if it is stolen it is useless without the private key.

Although we have described only one possible method for maintaining anonymity, there are other equivalents. For example, if the embodiment included telephone messaging, the identity of the user could be maintained using conventional voice modification techniques. If speculation 100 or user response 105 were in paper form, the form could be scanned using optical character recognition and translated into digital form, discarding any information that could be found in the original document.

Trusted Server Embodiment

In one embodiment of the present invention, central controller 200 is separated into three distinct elements: operations server 160, trusted server 165, and bonding agency 170. Each server performs a distinct task in the process of managing speculation 100. This separation makes it more difficult for attackers to compromise the system, as they must defeat the security of three separate systems instead of one. These servers work in conjunction with user1 interface 300 and user2 interface 400. Operations server 160 has the task of posting speculations 100, and accepts all transactions previously authenticated by trusted server 165. Trusted server 165 authenticates the identity of users, while bonding agency 170 verifies the ability of users to pay. In this embodiment, each server type may be distributed over a number of servers.

The following protocols describe the interactions of the three servers and assume the following:
1. Everyone knows the public keys of operations server 160, trusted server 165, and bonding agency 170.
2. The users have bond certificates 172, as discussed below.
3. Public keys can be used both for encrypting and for signing.

Before speculation 100 is accepted by operations server 160, it must bear the digital signature of both trusted server 165 and bonding agency 170. Because of this, speculation 100 contains two additional elements—a trusted server ID and a bond certificate.

Before speculation 100 may be submitted to central processor 200, the user must get approval from trusted server 165. This is required so that both the user and operations server 160 know that trusted server 165 is actually willing to accept speculation 100. Operations server 160 will not accept speculation 100 without a TRUSTED.sub.-ACCEPTANCE message as described below.

The trusted server 165, in turn, will not issue a TRUSTED.sub.-ACCEPTANCE unless it is convinced that the user's speculation 100 is fresh (not a replay), and that the user's ability to play is guaranteed by bonding agency 170. The user must also be convinced that he is being issued a fresh TRUSTED.sub.-ACCEPTANCE.

The protocol works as follows:
1. The user forms
   U.sub.0=“REQUEST FOR TRUSTED APPROVAL”
   X.sub.0=U.sub.0, speculation, R.sub.0, Additional Terms and sends to trusted server 165
   M.sub.0=PKE.sub.PK.sbsb.A (X.sub.0, Sign.sub.SK.sbsb.B (X.sub.0)).
2. Trusted server 165 responds with
   U.sub.1=“TRUSTED SPECULATION CHALLENGE”
   R.sub.1=a 160-bit random number
   X.sub.1=U.sub.1 hash (X.sub.0), R.sub.1 and sends to the user
   M.sub.1=PKE.sub.PK.sbsb.B (X.sub.1, Sign.sub.SK.sbsb.A (X.sub.1)).
3. The user responds to this with
   U.sub.2=“USER SPECULATION RESPONSE”
   X.sub.2=U.sub.2, hash (X.sub.1) and sends to trusted server 165
   M.sub.2=PKE.sub.PK.sbsb.A (X.sub.2, Sign.sub.SK.sbsb.B (X.sub.2)).
4. Trusted server 165 responds with
   U.sub.3=“TRUSTED SPECULATION ACCEPTANCE”
   T.sub.3=Timestamp
   X.sub.3=U.sub.3, hash (X.sub.3), T.sub.3, speculation and sends to the user
   M.sub.3=PKE.sub.PK.sbsb.B (X.sub.3, Sign.sub.SK.sbsb.A (X.sub.3)).
5. The user stores X.sub.3 as TRUSTED.sub-ACCEPTANCE

In order for operations server 160 to accept speculation 100 to be submitted to central processor 100, it must be convinced that speculation 100 has a fresh TRUSTED.sub.-ACCEPTANCE, and that it is guaranteed by bonding agency 170.

This works as follows:
1. The user forms
   R.sub.0=random 160-bit number
   U.sub.0=“SPECULATION SERVER SUBMISSION”
   X.sub.0=U.sub.0, R.sub.0, TRUSTED.sub-ACCEPTANCE and then sends to operations server 160
   M.sub.0=PKE.sub.PK.sbsb.S (X.sub.0, Sign.sub.SK.sbsb.B (X.sub.0)).
2. Operations server 160 receives M.sub.0 and verifies it. If it's fresh (not a replay), and if operations server 160 is willing to accept speculation 100, it forms
   R.sub.1=a random 160-bit number
   U.sub.1=“SERVER SPECULATION CHALLENGE”
   X.sub.1=U.sub.1, hash (X.sub.0), R.sub.1 and then encrypts and sends to the user
   M.sub.1=PKE.sub.PK.sbsb.B (X.sub.1, Sign.sub.SK.sbsb.S (X.sub.1)).
3. The user forms
   U.sub.2=“SPECULATION RESPONSE TO SERVER CHALLENGE” and then sends to operations server 160
   M.sub.2=PRE.sub.PK.sbsb.S (X.sub.2, Sign.sub.SK.sbsb.B (X.sub.2)).
4. If this message's signature verifies properly, then operations server 160 posts the speculation. Operations server 160 forms
   U.sub.3=“POSTED SPECULATION RECEIPT”
   Speculation=U.sub.3, hash (X.sub.2), speculation.
5. It then sends to the user
   M.sub.3=PKE.sub.PK.sbsb.B (speculation, Sign.sub.SK.sbsb.S (speculation)).

At the end of this protocol, the user has a receipt to acknowledge that his speculation 100 has been accepted and submitted to central processor 200, and operations server 160 is convinced that the holder of bond certificate 172 has just submitted speculation 100, and has the approval of trusted server 165.

The potential buyer has a bonding certificate 172 (BC.sub.P) of his own. Before he is allowed to view a speculation 100 in real time, he must go through a protocol. (People may browse the list of users' statistics with speculations to view, but nobody is allowed to purchase speculation information until they go through this protocol). The purpose of the protocol is to prove that the buyer is guaranteed by bonding agency to be capable of paying, and also to decrease the computational load on operations server 160 by establishing a secret authentication key, K.sub.p. All of this decreases the computational expense of allowing the potential buyer to browse speculations 100.
1. The potential buyer forms
   R.sub.0=a random 160-bit number
   T=a time range
   U.sub.0=“REQUEST FOR ACCESS TO VIEW”
   X.sub.0=U.sub.0, R.sub.0, T, BC.sub.P and sends to operation server 160
   M.sub.0=PKE.sub.PK.sbsb.S (X.sub.0, Sign.sub.SK.sbsb.P (X.sub.0))
2. Operations server 160 decides whether to grant the potential buyer access. If so it forms
   R.sub.1=a random 160-bit number
   U.sub.1=“SERVER VIEW-ACCESS CHALLENGE”
   X.sub.1=U.sub.1, hash (X.sub.0), R.sub.1 and sends to the potential buyer
   M.sub.1=PKE.sub.PK.sbsb.P (X.sub.1, Sign.sub.SK.sbsb.S (X.sub.1)).
3. The potential buyer responds by forming
   U.sub.2=“VIEW-ACCESS RESPONSE” and sends to operations server 160
   M.sub.2=PKE.sub.PK.sbsb.S (X.sub.2, Sign.sub.SK.sbsb.P (X.sub.2)).
4. Operations server 160 verifies the signature, and then responds by forming
   U.sub.3=“BINDING KEY”
   K.sub.p=a random secret key to be used for buying speculations 100.
   T=a time range (from first protocol message)
   X.sub.3=U.sub.3, hash (X.sub.2), T, K.sub.p and sends to the potential buyer
   M.sub.3=PKE.sub.PK.sbsb.P (X.sub.3, Sign.sub.SK.sbsb.S (X.sub.3)).

At the end of this protocol, the potential buyer holds the secret shared key with which he is allowed to buy speculation 100, within the time limits specified in the last message. The potential buyer and operations server 160 are both convinced that they have interacted with one another in real-time, and operations server 160 knows that the potential buyer's capacity to pay for purchased speculations 100 are guaranteed by bonding agency 170.

As a user meets or exceeds the standards desired by the managing company, a PO 120 is sent to him through operations server 160, authenticated under K.sub.p, and including a random challenge to prevent replay attacks. When the user wants to accept PO 120, he forms payment offer response 130, and sends it, along with the hash of the authenticated payment offer, authenticated under K.sub.p. Operations server 160 is convinced that this is a valid offer to accept PO 120, and that it's happening in real time. It responds by sending him BOUND.sub.-PO.
1. Operations server 160 forms
   U.sub.0=“PO OFFER”
   R.sub.0=a random 160-bit number
   R.sub.0=U.sub.0, R.sub.0, PO description and sends the user
   M.sub.0=PKE.sub.PK.sbsb.P (X.sub.0, Auth.sub.K.sbsb.p (X0)).
2. The user forms
   U.sub.1=“PO OFFER TO BIND”
   R.sub.1=a random 160-bit number
   X.sub.1=U.sub.1, hash (X.sub.0), R.sub.1, Offer Details and encrypts and sends to operations server 160
   M.sub.1=PKE.sub.PK.sbsb.S (X.sub.1, Auth.sub.K.sbsb.p (X.sub.1)).
3. If the offer is acceptable to operations server 160, then it forms
   U.sub.2=“SERVER BINDING OF PO”
   T=timestamp
   X.sub.2=U.sub.2, hash (X.sub.1), BC.sub.P, T, PO, Offer Details and encrypts and sends to the user
   M.sub.2=PKE.sub.PK.sbsb.P (X.sub.2, Sign.sub.SK.sbsb.S (X.sub.2)).
4. The user stores X.sub.2, Sign.sub.SK.sbsb.S (X.sub.2) as BOUND.sub.-PO.

The “Offer Details” field of BOUND PO specifies the conditions of PO 120. In most cases, this will involve allowing other users to view speculation 100 in exchange for payment, possibly in the presence of an agent from trusted server 165. In most cases, however, this will involve intermediaries, to preserve anonymity for the users. It is important that the user/seller has the BOUND.sub.-PO so that he can prove his identity to the intermediary with a simple challenge response protocol.

This set of protocols describes one possible implementation of an infrastructure to support PO's 120 and speculations 100. It is important to note that operations server 160, trusted server 165, and bonding agency 170 can conceivably be the same entity. In this case, these protocols can be dramatically simplified.

Applications of the Invention

In order to clarify the application of the present invention, the following examples demonstrate potential needs of users:

User: professional gambler
Submits speculations and agrees to PO as a means of increasing income
Or, purchases speculations of other users in order to increase his odds of winning at gambling locations

User: gambles for entertainment
Submits speculations to assess his personal success rates

User: cautious gambler
Views speculations of other users in order make a more informed choice at gambling locations

Those skilled in the art will recognize that the method and apparatus of the present invention has many applications, and that the present invention is not limited to the representative examples disclosed herein. Moreover, the scope of the present invention covers conventionally known variations and modifications to the system components described herein, as would be known by those skilled in that art.

1. A method for using a computer to provide a means of monitoring an individual's gambling success statistics, of allowing a user/buyer to view the speculation posted by a different user/seller, and providing compensation to the user for allowing the information to be made available, comprising:
inputting into the computer user-identification;
selecting a game choice;
submitting a speculation, the kind of allowable speculation and required details being responsive to the game choice;
displaying a list of the number of bids and percent of game wins for each user;
entering a payment agreement with select users based upon user's performance in the game of choice;
requesting a particular user's speculation information for a game of choice, which also requires a purchase price;
inputting into the computer a payment identifier specifying a credit card account, the payment being associated with the purchase price;
outputting the speculation information purchased after receiving the payment; and
providing a payment to the seller.

2. The method of claim 1, in which the step of inputting user identification comprises:
inputting a user name, identification number or other means of identifying the user;
inputting a password or other means of authorization and confirmation that the user is indeed the individual identified;
confirming the match of the identification and the authorization;

3. The method of claim 1, in which the step of entering into a payment agreement with a user comprises:
identifying a user who has reach a specific level of performance in a game of choice;
tendering a payment offer (PO) to the user for permission to offer user's speculation information for sale to potential buyers in exchange for payment to the user an amount consisting of a specific percentage of said sales, or a flat amount;
inputting into the computer acceptance of payment agreement offer by user;
inputting into the computer the method of payment to the user.

4. The method of claim 1, in which the step of requesting purchase of a user's speculation information comprises:
identification of those users that are also sellers, the list of users and sellers being associated with the game choice;
outputting by the computer the type of information that is provided by the sale, as well as the cost of the sale;
selection of a seller by the buyer, thereby determining the exact information being sold;
and confirmation of buyer's intent to purchase information.

5. The method of claim 1, in which the step of inputting into the computer the payment identifier comprises:
determining if a predetermined amount is available in the credit card account, with the amount being associated with the cost of the sale.

6. The method of claim 1, in which the step of outputting the information purchased after receiving the payment identifier comprises:
display of the information purchased, the information being associated with the seller's speculation.

7. The method of claim 1, in which the step of providing payment to seller comprises:
holding the amount to be paid to the seller in escrow for a pre-agreed upon amount of time, such as weekly, monthly, or quarterly, with the amount to be paid being associated with the previously established percentage of the sale cost or flat rate;
and rendering payment to the seller via preferred method, such as direct deposit or check.

8. The method of claim 1 further comprising:
the option of allowing a buyer to log in, thereby using previously submitted payment identification;
and the option of requesting for payment identification with each purchase.

9. An apparatus for facilitating communications between managing company and users comprising:
a storage device;
a processor connected to the storage device;
a program for controlling the processor;
the processor operative with the program to allow users to submit speculations with no money changing hands and to monitor wins and losses for each user;
the processor operative with the program to receive a payment offer based on user's performance with aforementioned speculations;
the processor operative with the program to allow users to select a seller, the seller being associated with the game of choice and a corresponding payment offer;
the processor operative with the program to receive a payment identifier specifying a credit card account, the payment identifier being associated with the purchase price;

10. The apparatus of claim 9, in which the processor is further operative to the program to:
allow a user to select a game of choice such as a sport, lottery, or other game that includes making a bid with returns based upon the odds of winning a bet;
allow a user to submit a speculation as to the outcome of the game with or without a monetary amount involved in the speculation, with the allowable speculation details being based upon the game chosen;
receive data regarding the actual outcome(s) of the game(s) being played;
compile statistical data relating to each player's success, which may include, but is not limited to: number or percent of wins and losses overall and per game of choice, and the amount of money that the user would have won if the speculations had not been purely inquisitive;

11. The apparatus of claim 9, in which the processor is further operative to the program to:
send an offer of payment based upon user's wins and losses with previously submitted speculations;
receive acceptance of the payment offer;

12. The apparatus of claim 9, in which the processor is further operative to the program to:
display win/loss statistics for each user which may be overall or detailed according to game choice and other criteria;
clearly define those users whose speculations may be viewed (sellers) and at what price, based upon the acceptance of payment offer and the game of choice;
allow a user to select an eligible seller whose speculation is desired for viewing;
receive a payment identifier specifying a credit card account, the payment identifier being associated with the selected user and game choice;
determine if a predetermined amount is available in the credit card account;
output to the buyer a request for an authorization to use the payment identifier to provide payment;
receive the authorization from the buyer in response to the request;
transfer payment from the buyer;
display the information purchased;
transfer payment to an escrow account on behalf of the seller, with the amount of the payment associated with the payment offer;
at predetermined intervals transfer payment from escrow to the seller.
